(19) United States
(12) Patent Application Publication
(10) Pub. No.: US 2016/0232349 A1
(43) Pub. Date: Aug. 11, 2016

(54) MOBILE MALWARE DETECTION AND USER NOTIFICATION

(71) Applicant: Fortinet, Inc., Sunnyvale, CA (US)

(72) Inventor: Rainer Baeder, Leinfelden-Echterdingen (DE)

(73) Assignee: FORTINET, INC., Sunnyvale, CA (US)

(21) Appl. No.: 14/617,787

(22) Filed: Feb. 9, 2015

(51) Int. Cl. G06F 21/56; H04L 29/06

(52) U.S. Cl. CPC G06F 21/561; H04L 63/145; H04L 63/1416

(57) ABSTRACT

Methods and systems for detecting and responding to malware events associated with mobile/portable computing devices by means of a malware detection gateway device associated with a mobile service provider network are provided. According to one embodiment, a malware detection gateway device associated with a mobile service provider network detects a malware event based on a data stream transmitted to or from a portable computing device communicating with a packet data network via the mobile service provider network. Responsive thereto, the malware detection gateway device causes a malware reporting/notification message to be sent to a user of the portable computing device by sending a malware indicating message, including an Internet Protocol (IP) address of the portable computing device, to a lookup device.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2014, Fortinet, Inc.

### BACKGROUND

1. Field

Embodiments of the present invention generally relate to the field of computer networks. In particular, various embodiments relate to methods and systems for detecting mobile malware and reporting the same to a user concerned with the detected malware.

2. Description of the Related Art

Mobile or portable data processing devices are becoming more common and increasingly powerful. As the processing capabilities of mobile devices, including, but not limited to, mobile phones, smartphones, tablet PCs, and personal digital assistants (PDAs), are increasing, these mobile devices are increasingly becoming targets of computer viruses and other types of malware. Malware typically refers to undesired code, software of a file, which may interrupt the normal functioning of a device and which is usually intended to damage, disable or take partial control over operation of the device or capture personal information. Malicious content may comprise viruses, trojans, worms, or any other malicious programs/code that implement various attacks and may spread across devices.

At the same time, with the sales of mobile/portable computing devices now exceeding those of laptops and desktops, sensitive and critical data is now frequently transacted on such mobile devices making it more lucrative for intruders or attackers to focus on disrupting the functioning of mobile devices to gain access to them. Furthermore, for several reasons, such as the poor quality and quantum of signature deployment, battery consumption required to run mobile security applications, the software architecture of mobile devices, limitations of mobile device operating systems and complex device management issues, such as potentially limited bandwidth while roaming, among others, security of mobile computing devices is weaker than that of laptops and like devices.

Existing mobile malware scanners also face issues relating to performing regular updates where malware definition data must be kept up to date in order for them to provide reasonable protection. Malware also changes constantly, requiring continual updates of malware definition at mobile devices to stay current/up to date in order to detect new malware. Furthermore, mobile handsets, especially those with limited processing capability and operating systems or those that do not permit memory access for malware scanning, will require some other method of verifying that resident applications are free of malware. Also, comprehensive signature matching as a virus or malware detection method on memory-constrained devices, like mobile phones, is difficult to efficiently implement due to the need for a large database of identified malware signatures. String matching is also processor intensive and results in a high computational tax on a mobile device, especially when existing mobile platforms have relatively low processing power. Large processing and memory requirements generally result in lower performance and excessive battery drain on mobile devices. Therefore, use of anti-virus or intrusion prevention system (IPS) based security tools installed on the mobile/portable devices are generally not a good fit for current mobile devices.

There is therefore a need for an improved malware detection and notification system and method for mobile devices.

### SUMMARY

Methods and systems are described for detecting and responding to malware events associated with mobile/portable computing devices by means of a malware detection gateway device associated with a mobile service provider network. According to one embodiment, a malware detection gateway device associated with a mobile service provider network detects a malware event based on a data stream transmitted to or from a portable computing device communicating with a packet data network via the mobile service provider network. Responsive thereto, the malware detection gateway device causes a malware reporting/notification message to be sent to a user of the portable computing device by sending a malware indicating message, including an Internet Protocol (IP) address of the portable computing device, to a lookup device.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary mobile malware detection architecture in accordance with an embodiment of the present disclosure.

FIG. 2 illustrates exemplary functional modules for detecting and reporting mobile malware in accordance with an embodiment of the present disclosure.

FIGS. 3A, 3B, and 3C illustrate exemplary embodiments of reporting malware to a user in accordance with various aspects of the present disclosure.

FIG. 4 is an exemplary sequence block diagram conceptually illustrating malware detection processing in accordance with an embodiment of the present disclosure.

FIG. 5 illustrates an exemplary representation of a lookup table in accordance with an embodiment of the present disclosure.

FIG. 6 is an exemplary flow diagram illustrating malware detection and notification processing in accordance with an embodiment of the present disclosure.

FIG. 7 is an exemplary computer system in which or with which embodiments of the present invention may be utilized.

### DETAILED DESCRIPTION

Methods and systems are described for detecting malware on a mobile/portable computing device by means of a network device, and sending message from the network device to the mobile/portable device upon detection of the malware. Methods and systems are provided for detecting malware on a portable device by a network device that is, for instance, managed by a mobile/network service provider, and notifying the portable device about the potential malware threat. As used herein detecting malware or a malware event generally include, but are not limited to, detection of software, malicious code, macros and the like (e.g., viruses, Trojans, worms, spyware) that may be used to disrupt computer operation, gather sensitive information and/or gain access to private computer systems and detection of an attempt to connect to known or blacklisted Internet Protocol (IP) addresses (e.g., those known to be associated with spam delivery, those known to be compromised, those known to be associated with a botnet, websites having poor reputations or those otherwise known to be associated with fraudulent and/or malicious domains).

According to one embodiment, method of the present disclosure can include detecting, by means of a malware detection gateway associated with a mobile service provider network, malicious content within a data stream transmitted to/from a portable computing device communicating with a packet data network via the mobile service provider network, and causing a malware reporting/notification message to be sent to a user of the portable computing device, by sending, through the malware detection gateway device, a malware indicating message to a look up device, wherein the malware indicating message comprises an IP address of the portable computing device. In an exemplary implementation, look up device can be configured to receive the malware indicating message from the malware detection gateway device, and then identify/extract user details based on the IP address present in the malware indicating message, based on which the malware reporting/notification message can be sent to the user. According to another exemplary implementation, user details/information extracted from the lookup device can include mobility pattern of the user, calling patterns, message patterns, application usage patterns, types of content being accessed by the portable computing device, among other user attributes.

According to one embodiment, the malware indicating message can further include one or more of a time of detection of the malware event (e.g., malicious content), a type of malware associated with the malicious content (e.g., adware, backdoor, exploit, application, flame, monitoring, riskware, rootkit, trojan, work, etc.), a severity of the malware, a security policy violated, a type of security breach, details of the security breach, and properties of the malware.

According to one embodiment, the malware reporting/notification message can be sent to a user of the portable computing device by the malware detection gateway device based on the response received from the look up device, wherein the response can include user details. According to another embodiment, the malware reporting/notification message can be sent to a user of the portable computing device by the look up device responsive to the malware indicating message. According to another exemplary embodiment, the malware reporting/notification message can be sent to a user of the portable computing device by a network operator of the mobile service provider network responsive to the malware indicating message.

According to another embodiment, the malware reporting/notification message can be sent to the user through one or more of a Short Message Service (SMS) message, a telephone call, an electronic mail (email) message, a Multimedia Messaging Service (MMS) message, wherein the malware reporting/notification message can include information regarding the detected malware event and giving the user a set time by which to address the issue (e.g., removal of malicious content).

According to another embodiment, the malicious content can include one or more of a virus, a trojan, an exploit, an attack, spyware, an expected data stream, blocked content, a security breach and a security violating application. According to another embodiment, the look up device can include or form part of a Policy Control and Resource Function (PCRF) of the mobile service provider network. In yet another embodiment, the look up device can include or form part of a Mobile Device Management (MDM) function of the mobile service provider network.

According to an embodiment, the malware indicating message can include one or more of a Diameter message a Remote Authentication Dial In User Service (RADIUS) message and a Simple Network Management Protocol (SNMP) message.

According to another embodiment, malicious content can be detected by performing pattern matching of content of the data stream with one or more of signatures or rules that are defined manually or automatically based on organization policies, or the user/network administrator. In yet another embodiment, malware detection gateway device can be configured to log the detected malicious content into a log database or any other storage structure.

According to one embodiment, system of the present disclosure can include a malware detection gateway device logically interposed between a mobile service provider's network and external packet data networks (e.g., an operator-external public packet data network (e.g., the Internet) or operator-external private packet data network or an intra-operator packet data network). In one embodiment, the malware detection gateway device may be physically located within the mobile service provider's network at a reference point between the service provider's packet data network gateway (PDN GW) (e.g., at the Gi interface (for 3G networks), SGi interface (for 4G networks) or the Internet interface or WLAN/Intranet interface (for WLAN networks)) and external packet data networks and maybe may be operatively coupled with a network operator, wherein the malware detection gateway device processes data streams from mobile devices and, using one or more signatures/rules, identifies malicious content transmitted to or from the mobile devices and/or malware running on the mobile devices. The identified malicious content or malware can then be processed to generate a malware-indicating message, which can be sent to a lookup table/device and/or to a mapping database such as Policy Control and Resource Function (PCRF) and/or Mobile Device Management (MDM) for identifying the user(s) impacted by the malware. Identified user(s) can then be notified through a notification means to allow the users to take appropriate action. In the context of the present disclosure, malware is to be broadly construed and may include, but is not limited to, viruses, trojans, exploits, attacks, spyware, expected data stream, blocked content, security breaching data, security violating applications, among other such undesired activities which violates defined security policies.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

If the specification states a component or feature “may”, “can”, “could”, or “might” be included or have a characteristic, that particular component or feature is not required to be included or have the characteristic.

Although the present disclosure has been described with the purpose of detecting and notifying malware to users of portable devices, it should be appreciated that the same has been done merely to illustrate the invention in an exemplary manner and any other purpose or function for which the explained structure or configuration can be used, is covered within the scope of the present disclosure.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are only for illustrative purposes and, thus, are not intended to be limited to any particular construction/structure.

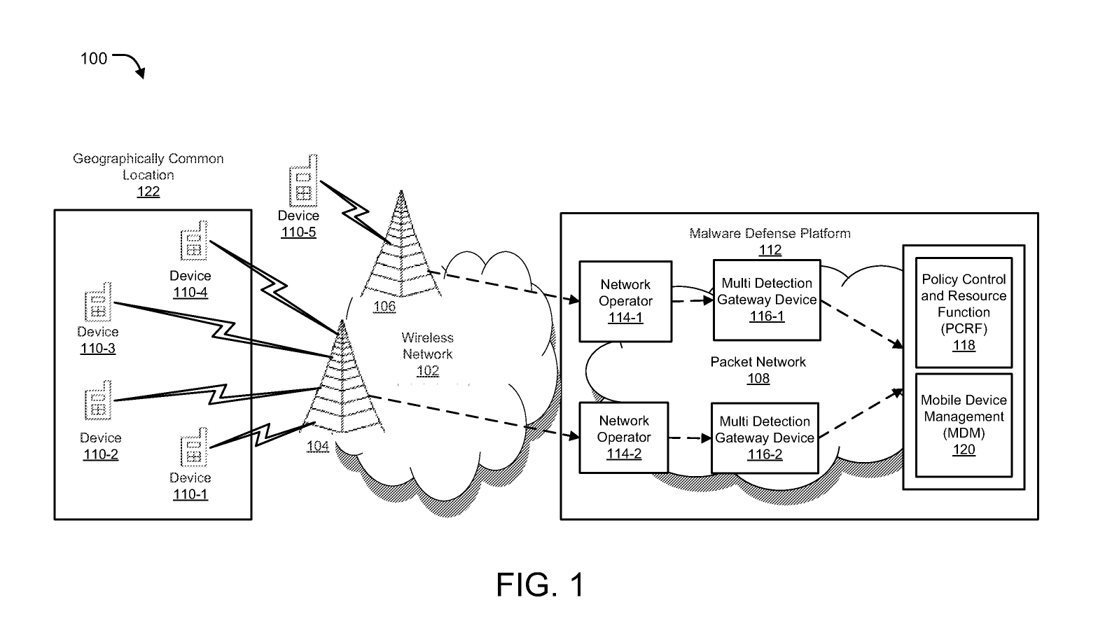

FIG. 1 illustrates an exemplary mobile malware detection architecture 100 in accordance with an embodiment of the present disclosure. As illustrated, architecture 100 of FIG. 1 can include a wireless packet network 102, which may also interchangeably be referred to as mobile service provider's network 102 hereinafter. Mobile service provider's network 102 may be configured to include one or more communication towers, such as 104 and 106, to provide mobile/wireless access to one or more mobile or portable computing devices. In an example illustration, one or more mobile or portable computing devices, such as device 110-1, device 110-2, device 110-3, device 110-4, and device 110-5, which may collectively and interchangeably be referred to as devices 110 hereinafter, can be configured to access different web services, network resources, and browse various websites from external packet data networks (not shown) using network 102 that is associated with at least one mobile service provider.

Content/data/information accessed by computing devices 110 from external packet data networks may include malware, such as viruses, attacks, trojans, undesired applications, among other such malware, which may harm the devices 110 or even the functioning of network 102, and/or can put the devices 110 or network 102 at risk as a result of coming into contact with a malicious and/or fraudulent website, for example. According to one embodiment, architecture 100 therefore includes a logical or physical malware defense platform 112 having one or more malware detection gateway devices, such as 116-1 and 116-2, which may be collectively referred to as malware detection gateway devices 116 hereinafter. According to one embodiment, malware detection gateway devices 116 can be configured, controlled, and/or managed by one or more network operators, such as 114-1 and 114-2, which may be collectively referred to as 114 hereinafter. In another embodiment, platform 112 further includes a lookup device 108 configured to, based on an input attribute, for example, an IP address, identify user details to which the input attribute pertains. Those skilled in the art will appreciate that although platform 112 has been shown separate from network 102, platform 112 or any component therefore of, such as malware detection gateway devices 116 can be configured remotely or locally or may be implemented within network 102, and therefore any such constructions, structures, or architectures are within the scope of the present disclosure.

According to one embodiment, malware detection gateway device 116 is associated with mobile service provider network 102 and configured to detect malicious content within a data stream transmitted to/from a portable computing device 110 communicating with a packet data network, such as an external network (not shown), via network 102. Malware detection gateway device 116 may also be configured to cause a malware reporting/notification message to be sent to the user of the portable computing device 110 by sending a malware indicating message to lookup device 108, wherein the malware indicating message comprises an IP address of the portable computing device 110. In an exemplary implementation, look up device 108 may be configured to receive the malware indicating message from the malware detection gateway device 116 and then identify/extract user details based on the IP address present in the malware indicating message, based on which the malware reporting/notification message or a similar or different reporting/notification message can be sent to the user of portable computing device 110. According to another exemplary implementation, user details/information extracted by lookup device 108 can include one or more of a mobility pattern of the user, calling patterns, message patterns, application usage patterns, types of content being accessed by portable computing device 110, among other user, device, usage and/or content attributes.

According to one embodiment, malware detection gateway device 116 is configured to determine details of both the sender (the source) of the malicious content/malware as well as details of the intended recipient of the content based on the attributes of the content, such as the source-destination IP addresses. Lookup device 108 and/or database or any other repository can be used to extract/map details of the sender and/or of the recipient, wherein the details can include information regarding access/usage history of wireless packet network 102, call logs, messages, among other user, device, usage and/or content details.

According to one embodiment, the malware indicating message can further include one or more of a time of detection of the malicious content, a type of malware associated with the malicious content, a severity of the malware, a security policy violated, a type of security breach, details of the security breach, and properties of the malware.

According to one embodiment, the malware reporting/notification message can be sent to the user of portable computing device 110 by malware detection gateway device 116 based on the response received from look up device 108, wherein the response can include user details. The malware reporting/notification message may be sent via an in-band messaging approach (e.g., via a Short Message Service (SMS) message or the like directed to the phone number associated with the device at issue or via an out-of-band messaging approach (e.g., via an SMS message directed to an alternative phone number associated with the user of the device at issue or via an electronic mail (email) message directed to an email account associated with the user of the device at issue). In one embodiment, the malware reporting/notification message can be sent to the user of portable computing device 110 as a result of direction from malware detection gateway device 116. For example, responsive receipt of a command or a malware indicating message from malware detection gateway device 116, look up device 108 may transmit the malware reporting/notification message or the like to the user of portable computing device 110. According to another exemplary embodiment, the malware reporting/notification message can be sent to the user of the portable computing device 110 by a network operator 114 of mobile service provider network 102 responsive to network operator 114 being informed of the malware detection event by way of the malware indicating message or the like.

According to another embodiment, the malware reporting/notification message can be sent to device 110 through one or more of a Short Message Service (SMS) message, a telephone call, an electronic mail (email) message, a Multimedia Messaging Service (MMS) message, wherein the malware reporting/notification message can include information regarding the detected malicious content and giving the user a set time by which to address the detected malicious content. When the malware is determined to have been sent from an external network and directed to device 110, device 110 can be informed of one or more of the name and/or type of malware detected, the source of the malware, the delivery mechanism by which the malware was directed to device 110, potential damage that the malware could have caused, history of the malware, access patterns of device 110, among other information, suggestions, and recommendations.

According to another embodiment, the malicious content can include one or more of a virus, a trojan, an exploit, an attack, spyware, an unexpected data stream, blocked content, a security breach and a mobile application that violates security policies specified for device 110. According to another embodiment, look up device 108 can include or form part of a Policy Control and Resource Function (PCRF) 118 of mobile service provider network 102/platform 112, wherein PCRF 118 can be configured to return user details based on a unique user identifier provided by malware detection gateway device 116, for example. In yet another embodiment, look up device can include or form part of a Mobile Device Management (MDM) function 120 of mobile service provider network 102/platform 112, wherein MDM functions are typically used to register/deregister mobile devices within mobile network 102. MDM function 120 can used by an enhanced messaging server, for example, to determine if mobile device 110 is registered (connected) as well as to determine the message delivery path. In an exemplary implementation, lookup device 108 can be configured to determine and return an identity of device 110 with the affected malware in the form of an International Mobile Station Equipment Identity (IMEI) code, an International Mobile Subscriber Identity (IMSI) code, a subscriber number, a mobile number and/or a user identifier of device 110 associated with the supplied input attribute (e.g., an IP address of device 110).

According to another embodiment, malicious content can be detected by performing pattern matching of content within the data stream with one or more of signatures or rules that are defined manually or automatically based on organization policies, or a user/network administrator. In yet another embodiment, malware detection gateway device 116 can be configured to log the detected malicious content into a log database or any other storage structure. In an example implementation, upon detection of malware on portable device 110, appropriate action(s) can be taken by the user of the portable device 110 and/or by the network operator 114 (if authorized) so as to black list, block, isolate, quarantine or otherwise prevent further access to the detected malware on the device 110 and/or to content attempted to be accessed by the detected malware.

In another exemplary embodiment, identification of computing device 110 can be done based on the malware indicating message originated by malware detection gateway device 116, which can, in an implementation, include a diameter message or a Remote Authentication Dial In User Server (RADIUS) message that can help the look up device 108 in associating and/or mapping the IP address of user device 110 at any instant of time with an IP assignment/mapping/look up table or database containing IP addresses assigned to user devices 110.

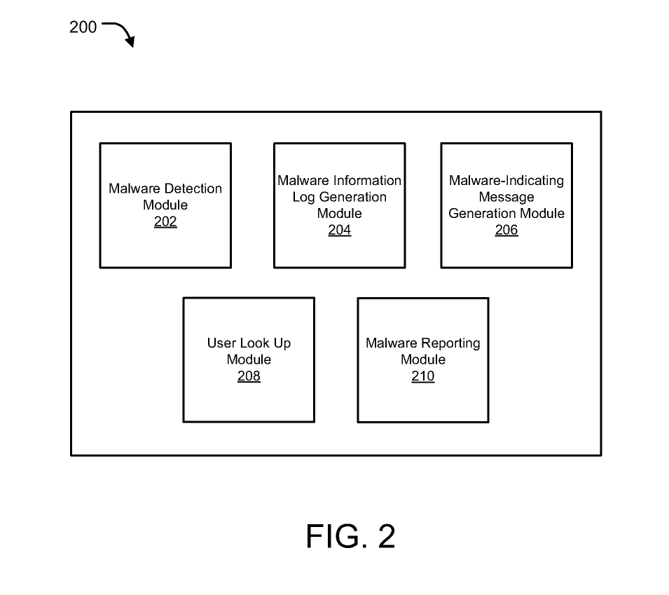

FIG. 2 illustrates exemplary functional modules 200 for detecting and reporting mobile malware in accordance with an embodiment of the present disclosure. In an aspect, the system described herein for detecting malware on portable computing devices or intended for portable computing devices, such as mobile phones, tablets, smart phones, among others, and for issuing appropriate notifications relating thereto can be implemented by means of one or more processors, a communication interface device, and one or more internal data storage devices operatively coupled to the one or more processors and storing a malware detection module 202, a malware information log generation module 204, a malware-indicating message generation module 206, a user look up module 208, and a malware reporting module 210. One or more of these modules such as malware detection module 202, malware information log generation module 204, malware-indicating message generation module 206, and malware reporting module 210 can be implemented by a first network device associated with a mobile service provider, and one or more of these modules, such as user look up module 208 and malware reporting module 210, can be implemented by a second network device associated with the mobile service provider, wherein the two network devices associated with the network service provider can be logical (virtual) or physical devices. Alternatively, modules 200 may be implemented within a single computing device. Any other number of modules and/or sub-modules can also be incorporated and all such configurations are within the scope of the present disclosure.

According to one embodiment, malware detection module 202 can be configured to detect malicious content within a data stream transmitted to/from a portable computing device (that forms part of a mobile service provider network) that is communicating with a packet data network. Malware detection module 202 can be configured to detect malicious content, including, but not limited to viruses, trojans, exploits, attacks, spyware, unexpected data streams, blocked content, security breaches, mobile applications that violate one or more security policies and other suspicious user/device activity identified based on one or more defined parameters/criteria/rules/signatures indicative of the presence of malware.

In an exemplary implementation, malicious content can be identified by malware detection module 202 by performing pattern matching of content within a data stream received or transmitted by a portable computing device with one or more of signatures or rules or definitions associated with known malicious content. In an exemplary implementation, malware detection module 202 can be configured to maintain a list of signatures, rules and definitions to identify the malicious content, wherein such rules and signatures can be updated in real-time or at periodic intervals. In yet another implementation, signatures/rules/definitions of known malware can be obtained from third party vendors, or can be automatically synchronized with one or more third parties that provide such malware signatures/rules/definitions. In another exemplary implementation, malware detection module 202 can be configured to detect suspicious or unusual activity/behavior by the portable computing device by monitoring data flowing to/from the portable computing device by way of the mobile service provider network.

According to one embodiment, malware information log generation module 204 can be configured to generate a log of detected malicious content. Malware logs can be used for later offline analysis of detected malware events and/or to facilitate identification of the infected portable computing device(s) or sources of detected malicious content. The log, on one hand, can either be generated for the complete data stream including the malware, or can be generated only for the malicious content. Any other possible combination or format can also be used to create and update the log in real time. In an embodiment, for each detected malware, a log entry may be created with multiple fields including, but not limited to, the IP address of the mobile device for which the malware was detected, destination information, type of malware, severity of malware, details of malware, security policy violated by the malware, time of detection, among other parameters. Collected logs can also be used to update the signatures and/or rules that can later be used by malware detection module 202.

According to one embodiment, the malware-indicating message generation module 206 is configured to enable malware detection gateway device 116 to generate a malware indicating message based on various parameters associated with the malware detected by malware detection module 202, and to send the generated malware indicating message to a lookup device for determination of user details pertaining to the detected malware. According to embodiment, the malware indicating message can include an IP address of the portable computing device to which the detected malware was intended, from which the detected malware was originated and/or on which the detected malware was found to reside. According to another embodiment, the malware-indicating message may include several details relating to the detected malware, including, but not limiting to, the IP address of the infected/targeted portable computing device or the IP address of the external source of the malware, a timestamp indicating a time and/or date of the malware detection, information regarding a security policy violated, the type of malware detected, information regarding the severity of the detected malware, information or a link to information regarding how to remediate or protect the infected portable computing device or otherwise remove or disable the detected malware, information or a link to information providing a description of the detected malware. Malware-indicating message generation module 206 can be configured to send the generated malware-indicating message through a suitable communication means to the lookup device that can be configured to implement the look up module 208. In an example implementation, the malware indicating message generation module 206 can be configured to send malware-indicating message to the look up module 208 using a wired/wireless data network if the two modules are configured to be implemented on different computing devices, or can be configured to send the malware-indicating message to look up module 208 using a data bus if the two modules are configured to be implemented on the same computing device. According to one embodiment, the malware-indicating message can include a diameter message or Remote Authentication Dial In User Server (RADIUS) message that can help the look up module 208 to identify the portable device/user. In an exemplary implementation, the Diameter and/or RADIUS message can include information such as “IP address 192.168.123.XXXX; timestamp 123432345; violated security policy MN; malware code 1232; severity BBBB; source information; frequency;”, among other like parameters.

According to one embodiment, user lookup module 208 can be configured to receive the malware indicating message from the malware indicating message generation module 206, and identify a user/portable computing device corresponding to the IP address received as part of the malware-indicating message along with the time of malware detection. In an exemplary implementation, user lookup module 208 can be configured to identify the user/portable computing device corresponding to the IP address received as part of the malware-indicating message using a look up table that includes a mapping of the IP address with the user identifiers such as International Mobile Station Equipment Identity (IMEI) code and International Mobile Subscriber Identity (IMSI) code. In an exemplary implementation, the mapping table can keep an updated record of IP addresses assigned to different portable computing devices/users (at various times) along with their identifiers, which can be used by the user lookup module 208 to identify the user was assigned the IP address at issue at during the timeframe at issue (e.g., at the time of the malware detection). Based on the IP address of the device associated with the detected malware and the time of malware detection, user lookup module 208 can determine the identity of the user/portable computing device using the mapping table. According to one embodiment, apart from user identity, attributes of the user such as browsing history, call logs, message logs, usage pattern, among others can also be retrieved and processed to arrive at meaningful information that may assist the user or the mobile service provider in connection with countering the malware.

In an aspect, the look up device can include or form part of a Policy Control and Resource Function (PCRF) of the mobile service provider network. In another aspect, the look up device can include or form part of a Mobile Device Management (MDM) function of the mobile service provider network.

Upon detection of malware and the identification of user/portable computing device, malware reporting module 210 may be configured to send an alert message along with one or more recommendations and/or suggested action items to the affected user/portable computing device. According to one embodiment, malware reporting module 210 can be configured to notify the identified user of the malicious content being generated and/or being processed by him/her. In an implementation, the user can be sent a notification that is indicative of the nature of malware, extent of security policy breach, severity of malware, potential impact and/or consequences of the malware, along with suggestions that need to be complied with. The user can also be given a stipulated amount of time to implement the suggested solution, or take action(s) to rectify the identified problem. In an exemplary implementation, the malware-reporting module 210 can be configured to, automatically generate and send the malware reporting/notification message to the user based on and responsive to receipt of the malware indicating message from lookup device 108.

In an exemplary implementation, the malware reporting/notification message can include malware alerts with other specific details including, but not limiting to, type of malware associated with the malicious content, severity of the malware, security policy violated, type of security breach, details of the security breach, properties of the detected malware and one or more alternate appropriate actions that can be taken by the user/portable computing device for neutralizing the malware. In another exemplary implementation, the malware reporting/notification message can include details about applications/websites/services that may be associated with the malicious content and rectification measure that should be taken to prevent future infection. According to one embodiment of the present disclosure, malware reporting module 210 can be configured to send a malware reporting/notification message to the portable device/user in the form of a Short Message Service (SMS) message, an automated telephone call, an electronic mail (email) message or a Multimedia Messaging Service (MMS) message.

According to one embodiment, a first network device, also interchangeably referred to as a malware detection gateway device, can be configured to include malware detection module 202, malware information log generation module 204, malware-indicating message generation module 206, malware reporting module 210; and a second network device, also interchangeably referred to as a look up device, can be configured to include user look up module 208 and malware reporting module 210. In an exemplary implementation, the malware detection gateway device and the look up device can be configured to be logically or physically present on the same computing device or on different computing devices. One or more of these modules can also be implemented by a third party/a third network device, wherein, for instance, the malware reporting module 210 can be configured to be implemented by a third party that is configured to provide malware reporting and removal.

In an exemplary implementation, malware reporting/notification message generated by the malware reporting module 210 can be sent to the identified portable computing device/user by the malware detection gateway device responsive to receiving user details from the look up device, or directly by the look up device responsive to the malware indicating message, or by any other network device associated with network server provide responsive to receiving the malware indicating message and identified user details.

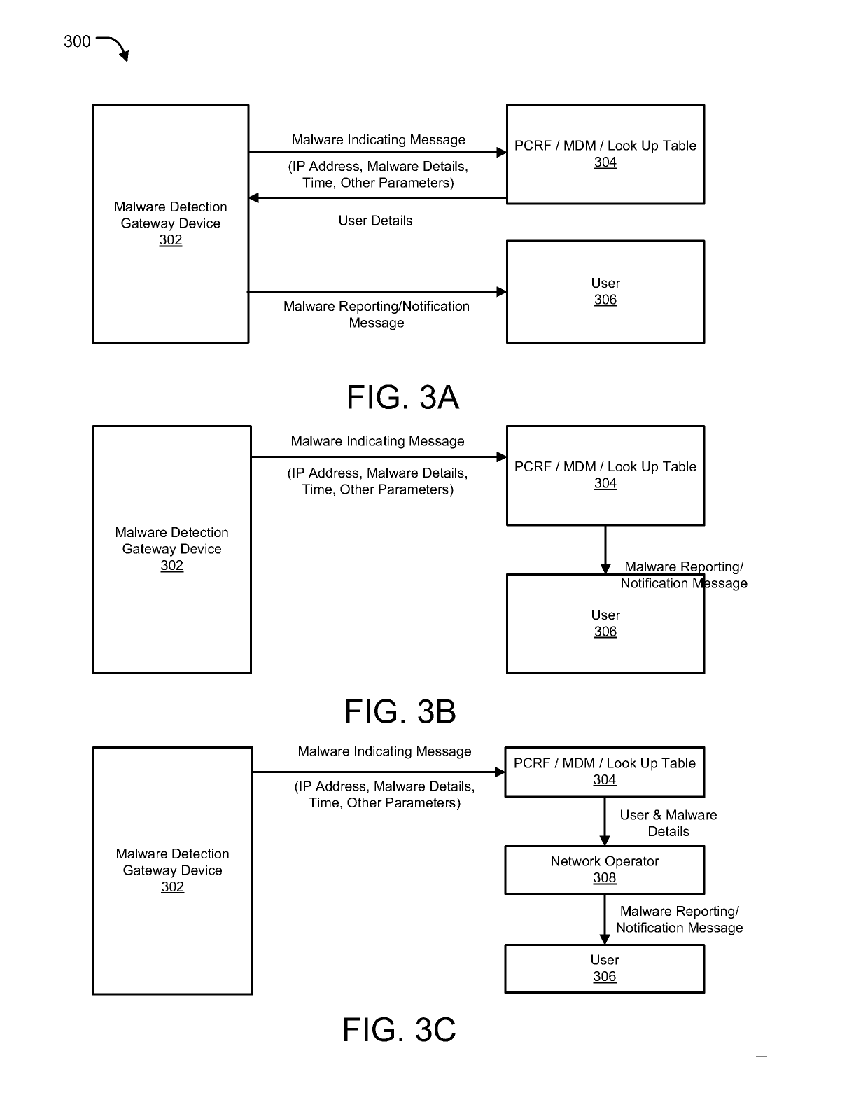

FIGS. 3A, 3B, and 3C illustrate various malware detection and reporting scenarios in accordance with embodiments of the present disclosure. As illustrated in FIG. 3A, malware detection gateway device 302 may be configured to detect malware based on rules/signatures/patterns/conditions, generate a malware indicating message, including an IP address associated with the affected mobile device and attributes/parameters of the detected malware, receive user details from PCRF/MDM/look up device 304 based on the malware indicating message, and finally send a malware reporting/notification message to a user 306 of the affected mobile device based on the received user details.

In another embodiment, as illustrated in FIG. 3B, malware detection gateway device 312 can be configured to detect malware, generate and send a malware indicating message to a PCRF/MDM/look up device 314, and enable the look up device 314 to process the received malware indicating message to generate intended user details and further enable the lookup device 314 to directly send the malware reporting/notification message to the intended user based on the generated user details.

In yet another embodiment as illustrated in FIG. 3C, malware detection gateway device 322 can be configured to detect the malware and generate/send a malware indicating message to a PCRF/MDM/look up device 324 based on the detected malware. The lookup device 324 can then, process the malware indicating message to identify user details corresponding to the attributes present in the malware indicating message, and send the user details to a network operator 326, who can then send the malware reporting/notification message to the identified user 328.

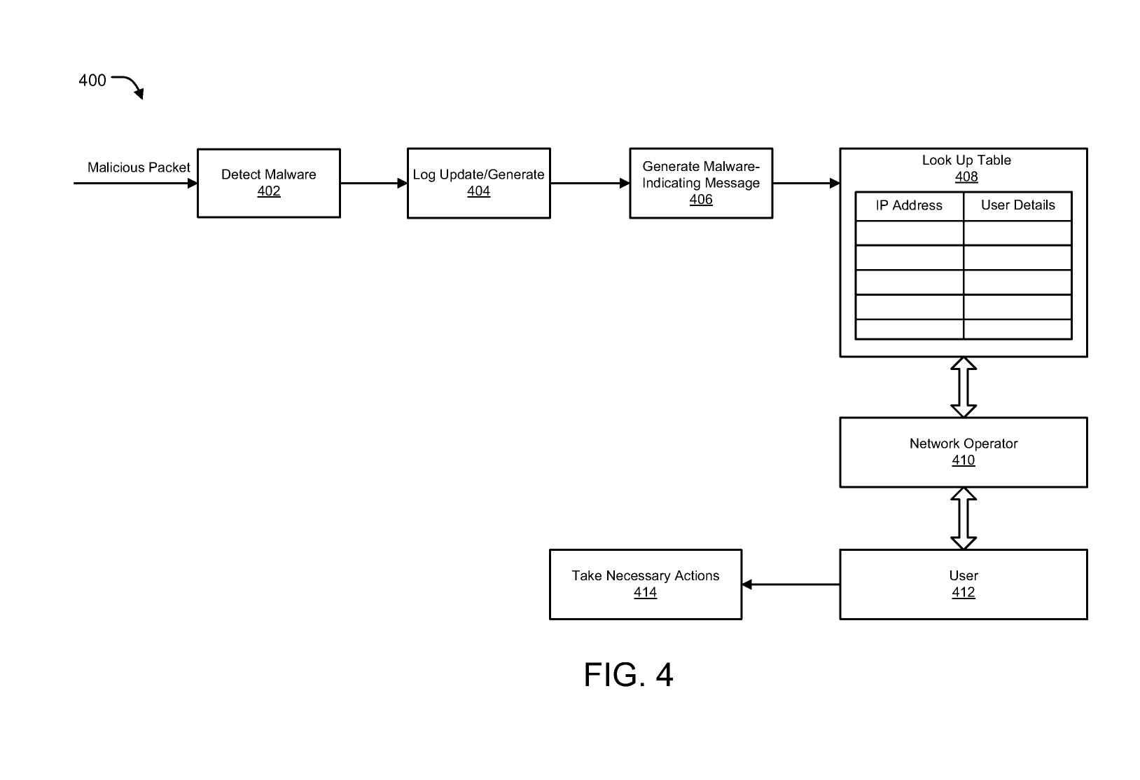

FIG. 4 illustrates an exemplary block diagram 400 illustrating malware detection processing in accordance with an embodiment of the present disclosure. As illustrated in FIG. 4, an exemplary implementation of the proposed system of the present disclosure includes detection of malware in incoming/outgoing data stream (bit pattern, data packets, visited websites, downloaded content, applications, and among other type of content) being accessed by one or more portable computing devices as shown in block 402. The detection can either be performed at a malware detection gateway device or at any other appropriate network device within a mobile service provider's network that is configured to receive data packets and based on one or more filters/criteria/rules, identify potential malicious content in transit or activity indicative of the existence of malware resident on a subscriber's mobile device.

At block 404, malware detection gateway device 116 generates and/or updates one or more malware logs based on the detected malware. At block 406, malware detection gateway device 116 generates a malware-indicating message based on the detection event, wherein the malware-indicating message can include information/attributes of malware along with user identifier information, such as an IP address of the mobile device at issue. Such a malware-indicating message can be sent to a lookup/mapping table 408 so as to extract user details corresponding to the user identifier information. As shown, lookup/mapping table 408 can be configured to store a mapping of IP addresses to User details, such as username, phone number, IMEI number, user attributes, history, phone logs, message logs, browsing history, among any other desired information. Those skilled in the art will appreciate that table 408 is a non-limiting conceptual illustration of a potential mapping and that such a mapping can be implemented in various manners. For example, the lookup process may involve a database query of a database associated with the mobile service provider's network.

As shown in FIG. 4, based on the user details retrieved from the lookup table 408, a network operator 410 can then issue a notification/reporting message to the user 412 associated with the affected mobile device in order to inform user 412 to take necessary actions, such as installing anti-virus software, avoiding particular web sites, etc. Network operator 410 may also take certain actions, such as blocking the user, reporting the activity to the organization, or any other action that can be envisaged. Network operator 410 may serve a quality control function for automatically generated notification/reporting messages, may manually generate all or some portions of the notification/reporting messages and/or may inform customer service representatives to contact user 412.

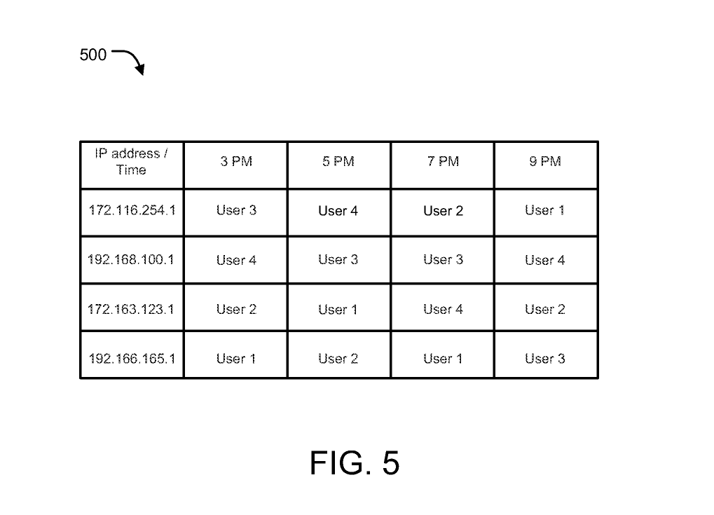

FIG. 5 illustrates an exemplary conceptual representation 500 of a lookup table in accordance with an embodiment of the present disclosure. Allocation of IP addresses by a network service provider (e.g., a mobile service provider) to user/portable computing devices may be dynamic in nature, and hence dynamic updates to look-up table 500 may be required. In a wireless network system, dynamic IP addresses can be assigned to a portable computing device when it needs to connect to a data network, for example.

In an example implementation, look table 500, as shown in FIG. 5, can be used by a PCRF/MDM/look up device to identify a user and/or associated user details that are associated with the IP address associated with the detected malware event. According to one embodiment, look up table 500 can be used for mapping of the IP address, received as part of the malware indicating message, with user identifiers/identification information, such as an IMEI code and/or an IMSI code, in order to identify the user and/or the specific portable computing device corresponding to the affected IP address. In an example implementation, look up table 500 can keep an updated record of IP addresses assigned to different portable computing devices/users along with their identifiers/details for multiple predefined or configurable timeframes. Based on the IP address of the mobile device associated with the malware detection event and time of malware detection, lookup table 500 can be used to determine the identity of the user/portable computing device. In the context of the present example, if the IP address specified within a malware indicating message received by lookup table 500 was 172.116.254.1 and the time of malware detection is specified as 5 PM, then user 4 is the affected user to which the malware reporting/notification message will be directed. Those skilled in the art will appreciate lookup table 500 changes over time as the mobile service provider dynamically assigns IP addresses to mobile devices of its subscribers and that such dynamic assignment results in the same IP address being associated with different users at different points in time. In an exemplary implementation, a network/mobile service provider can use a set of dynamic IP addresses, and can assign these IP addresses to different users at different points of time. For example, when a new user moves from one tower to another, the user's portable computing device may release its current IP address and be assigned a new one by the network/service provider. As can be seen from the FIG. 5, the same IP address (e.g., 172.116.254.1) may have been associated with several different users at differing times over the course of a span of hours. In the context of the present example, IP address 172.116.254.1 was associated with user 3 at 3 PM, with user 4 at 5 PM, with user 2 at 7 PM and with user 1 at 9 PM. Therefore it should be clear that the same IP address can be assigned to different users at different times and a single user can be assigned different IP address at different time. It is also possible to assign a static IP address to a given portable computing device, which greatly simplifies this lookup process. Any such dynamic or static assignment of IP addresses to mobile devices of a mobile service provider is within the scope of the present disclosure.

Though lookup table 500 illustrates mapping of IP addresses to usernames, it is within the scope of present disclosure to map IP addresses to various other identifiers, such as IMEI codes, IMSI codes or mobile telephone numbers.

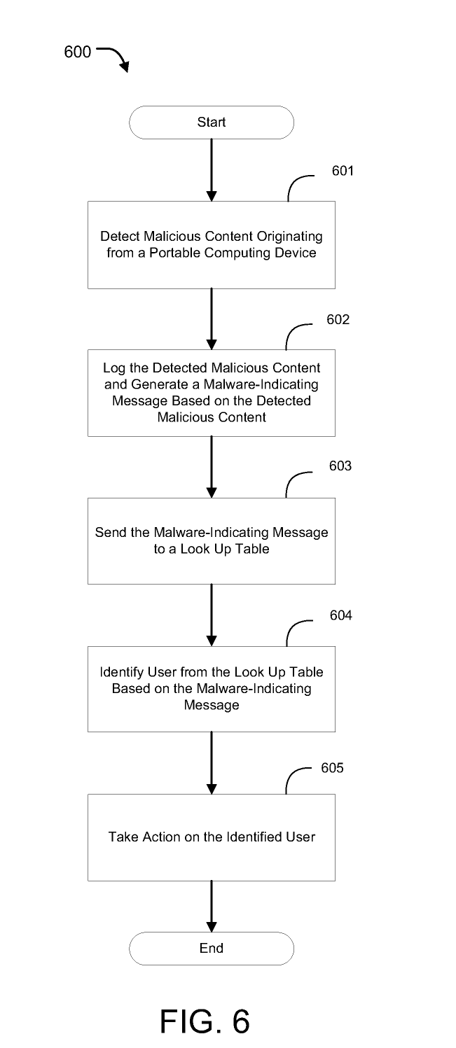

FIG. 6 is an exemplary flow diagram 600 illustrating malware detection and notification processing in accordance with an embodiment of the present disclosure. Example implementations described herein are directed to methods of detecting (i) malicious content in transit through a mobile service provider network that originated from a mobile device of a subscriber or is directed to a mobile device of a subscriber; or (ii) other activity indicative of the existence of malware on a mobile device of a subscriber; and responsive thereto automatically generating and sending a malware notification message to the affected user.

At step 610, a malware detection gateway device that is associated with a mobile service provider network can detect a malware event, e.g., malicious content within a data stream transmitted to/from a portable computing device communicating with a packet data network via the mobile service provider network or activity indicative of the existence of malware resident on the portable computing device.

At step 620, the malware detection gateway device can process the detected malware to generate a malware indicating message that, apart from malware attributes/parameters, includes an IP address of the portable computing device, and send the generated message to a lookup device.

At step 630, the lookup device can map the IP address received as part of the malware indicating message to user details of the portable computing device. Finally, at step 640, the retrieved user details can be used to send a malware reporting/notification message to the user of the portable computing device. The malware reporting/notification message may inform the user of one or more actions to take to prevent and/or remediate the situation. The malware reporting/notification message may also specify a timeframe within which the user must perform the actions. In one embodiment, upon expiration of the specified timeframe, the mobile service provider may take affirmative action to protect its network and/or other subscribers against harm from the mobile device in question by deactivating the user's service, for example.

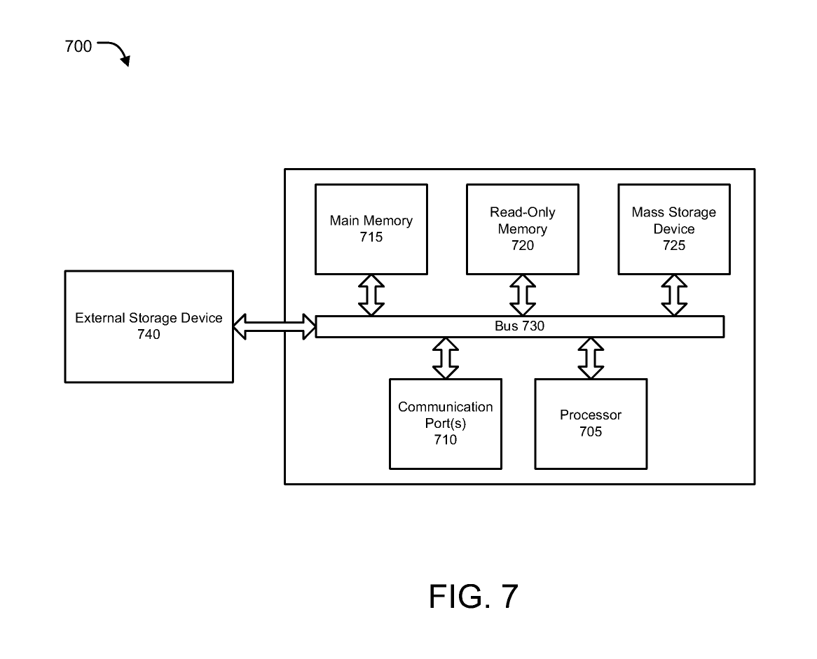

FIG. 7 is an example of a computer system 700 with which embodiments of the present disclosure may be utilized. Computer system 700 may represent or form a part of a one or more logical or physical network devices (e.g., malware detection gateway device 115, lookup device 108) operable within or otherwise associated with a mobile service provider network.

Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 700 includes a bus 730, a processor 705, communication port 710, a main memory 715, a removable storage media 740, a read only memory 720 and a mass storage 725. A person skilled in the art will appreciate that computer system 700 may include more than one processor and communication ports.

Examples of processor 705 include, but are not limited to, an Intel® Xeon® or Itanium® processor(s), or AMD®, Opteron® or Athlon MP® processor(s), Motorola® lines of processors, FortiSOC™ system on a chip processors or other future processors. Processor 705 may execute instructions associated with one or more of the various functional modules associated with malware defense platform 112. As such, processor may represent and/or perform the functionality of one or more of malware detection module 202, malware information log generation module 204, malware-indicating message generation module 206, user lookup module 208 and/or malware reporting module 210.

Communication port 710 can be any of an RS-232 port for use with a modem based dialup connection, a 10/100 Ethernet port, a Gigabit or 10 Gigabit port using copper or fiber, a serial port, a parallel port, or other existing or future ports. Communication port 710 may be chosen depending on a network, such a Local Area Network (LAN), Wide Area Network (WAN), or any network to which computer system 700 connects.

Memory 715 can be Random Access Memory (RAM), or any other dynamic storage device commonly known in the art. Read only memory 720 can be any static storage device(s) such as, but not limited to, a Programmable Read Only Memory (PROM) chips for storing static information such as start-up or BIOS instructions for processor 705.

Mass storage 725 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 730 communicatively couples processor(s) 705 with the other memory, storage and communication blocks. Bus 730 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 705 to system memory.

Optionally, operator and administrative interfaces, such as a display, keyboard, and a cursor control device, may also be coupled to bus 730 to support direct operator interaction with computer system 700. Other operator and administrative interfaces can be provided through network connections connected through communication port 710.

Removable storage media 740 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

What is claimed is:

1. A method comprising:
detecting, by a malware detection gateway device associated with a mobile service provider network, a malware event based on a data stream transmitted to or from a portable computing device communicating with a packet data network via the mobile service provider network; and
causing a malware reporting/notification message to be sent to a user of the portable computing device, by sending, by the malware detection gateway device, a malware indicating message to a lookup device, wherein the malware indicating message comprises an Internet Protocol (IP) address of the portable computing device.

2. The method of claim 1, wherein said detecting a malware event comprises observing activity of the portable computing device that is indicative of malware resident on the portable computing device.

3. The method of claim 1, wherein said detecting a malware event comprises detecting malicious content within the data stream.

4. The method of claim 3, wherein said detecting malicious content comprises performing pattern matching of content within the data stream with one or more of signatures or rules.

5. The method of claim 1, wherein the malware event is associated with one or more of a virus, a trojan, an exploit, an attack, spyware, an unexpected data stream, blocked content, a security breach and a security violating application.

6. The method of claim 1, wherein the malware indicating message further comprises one or more of a time of detection of the malicious content, a type of malware associated with the malware event, a severity of the malware, a security policy violated, a type of security breach, details of the security breach, and properties of the malware.

7. The method of claim 1, wherein said causing a malware reporting/notification message to be sent to a user of the portable computing device comprises sending, by the malware detection gateway device, the malware reporting/notification message to the user responsive to receiving user details from the lookup device.

8. The method of claim 1, wherein said causing a malware reporting/notification message to be sent to a user of the portable computing device comprises triggering the malware reporting/notification message to be sent by the lookup device responsive to the malware indicating message.

9. The method of claim 1, wherein said causing a malware reporting/notification message to be sent to a user of the portable computing device comprises triggering the the malware reporting/notification message to be sent by a network operator of the mobile service provider network responsive to the malware indicating message.

10. The method of claim 1, wherein the malware reporting/notification message comprises one or more of sending the user one or more of a Short Message Service (SMS) message, a telephone call, an electronic mail (email) message, a Multimedia Messaging Service (MMS) message and wherein the malware reporting/notification message includes information regarding the malware event and giving the user a set time by which to address the malware event.

11. The method of claim 1, wherein the lookup device includes or forms part of a Policy Control and Resource Function (PCRF) of the mobile service provider network.

12. The method of claim 1, wherein the lookup device includes or forms part of a Mobile Device Management (MDM) function of the mobile service provider network.

13. The method of claim 1, wherein the malware indicating message comprises a Diameter message.

14. The method of claim 1, wherein the malware indicating message comprises a Remote Authentication Dial In User Service (RADIUS) message.

15. The method of claim 1, further comprising, responsive to receipt of the malware indicating message, identifying the user by the lookup device based on the IP address.

16. The method of claim 14, further comprising extracting information relating to the user, wherein the information comprises calling patterns, message patterns, application usage patterns, types of content accessed by the portable computing device and user attributes.

17. The method of claim 1, further comprising logging, by the malware detection gateway, information regarding the malware event.

18. A malware detection system operable within a mobile service provider network comprising:
one or more processors;
a communication interface device;
one or more internal data storage devices operatively coupled to the one or more processors and storing instructions representing:
a malware detection module configured to detect malicious content within a data stream originating from or directed to a portable computing device communicating with a packet data network via the mobile service provider network;
a user lookup module configured to identify a user corresponding to the portable computing device based on a lookup table and a unique identifier associated with the portable computing device; and
a malware-indicating message module configured to query the user lookup module by providing information relating to the detected malicious content and the unique identifier;
a malware reporting module configured to notify the user of the detected malicious content.

19. The system of claim 18, wherein the information relating to the detected malicious content comprises one or a combination of a time of detection, a type of malware, severity of the malware, a security policy violated, a type of security breach, details of the security breach and properties of the malware.

20. The system of claim 18, wherein the unique identifier comprises an Internet Protocol (IP) address associated with the portable computing device.

21. The system of claim 18, wherein the malware reporting module is further configured to send a notification to the user in a form of one or more of a Short Message Service (SMS) message, a telephone call, an electronic mail (email) message, a Multimedia Messaging Service (MMS) message and wherein the notification includes information regarding the detected malicious content and giving the user a set time by which to take action to address the detected malicious content.

22. The system of claim 18, wherein malicious content comprises one or a combination of a virus, a trojan, an exploit, an attack, spyware, an unexpected data stream, blocked content and a security breach or a security violation.

23. The system of claim 18, wherein the lookup table forms part of a Policy Control and Resource Function (PCRF) of the mobile service provider network.

24. The system of claim 18, wherein the lookup table forms part of a Mobile Device Management (MDM) function of the mobile service provider network

25. The system of claim 18, wherein the lookup table is stored in a database operatively coupled with the mobile service provider network.

26. The system of claim 18, wherein the malware-indicating message module queries the user lookup module by sending the user lookup module a Diameter message.

27. The system of claim 18, wherein the malware-indicating message module queries the user lookup module by sending the user lookup module a Remote Authentication Dial In User Service (RADIUS) message.

28. The system of claim 18, wherein the user lookup module is further configured to extract information relating to the user, wherein the information comprises calling patterns, message patterns, application usage patterns, types of content accessed by the portable computing device and user attributes.

29. The system of claim 18, wherein the malware detection module is further configured to apply one or more rules to content within the data stream or match the content with one or more signatures.

30. The system of claim 18, further comprising a malware information log generation module configured to log information regarding detected malicious content.

31. The system of claim 18, wherein the portable computing device comprises a smartphone, a mobile phones a Personal Digital Assistant (PDA) or a tablet personal computer.
